(19) United States
(12) Patent Application Publication
(10) Pub. No.: US 2012/0031515 A1
(43) Pub. Date: Feb. 9, 2012

(54) Shutoff Valves for Fluid Conduit Connectors

(75) Inventor: Carl T. Whitaker, Berthoud, CO (US)

(73) Assignee: Value Plastics, Inc., Fort Collins, CO (US)

(21) Appl. No.: 13/204,589

(22) Filed: Aug. 5, 2011

Related U.S. Application Data
(60) Provisional application No. 61/371,415, filed on Aug. 6, 2010.

(51) Int. Cl. F16L 37/00; F16F 1/08

(52) U.S. Cl. 137/798; 267/166.1

(57) ABSTRACT

A shutoff valve for a fluid conduit connector has a housing and an integrally formed shutoff valve located within the housing. The integrally formed shutoff valve has a spring region that defines a lumen and a sealing feature on one or both ends. The spring region defines one or more fluid pathways between an outer surface and an inner surface of the integrally formed shutoff valve. The spring region may be a formed as a helical coil or a fenestrated tube. The sealing feature provides a fluid-tight seal between the housing and the integrally formed shutoff valve.

### CROSS REFERENCE TO RELATED APPLICATIONS

The present application claims the benefit under 35 U.S.C. §119(e) to U.S. Provisional patent application No. 61/371,415, which was filed on Aug. 6, 2010, and entitled “Shutoff Valves for Fluid Conduit Connectors,” which is hereby incorporated by reference herein in its entirety.

### BACKGROUND

Inline fluid conduit connectors may include valves configured to stop the flow of fluid when the connectors are disconnected. Such connectors may be referred to as shutoff connectors or couplers and they generally contain poppet or shutoff valves. Generally, shutoff couplers may include several independent parts configured to open and close of the shutoff or poppet valves contained therein. In particular, the valves typically may include a conduit, a spring member, a sealing member, and an interface member. The sealing member is coupled to the spring member. The spring member holds the sealing member in an extended position so that the valve is normally closed. The sealing member moves relative to the conduit so that the valve may be opened when coupled with another conduit.

The interface member generally provides a contact point for causing displacement of the sealing member when coupling conduits together. In one-sided shutoff connectors, a single shutoff valve may be implemented, while two-sided shutoff connectors include opposing shutoff valves configured with interface members that contact to compress the spring members and open the valves. When shutoff connectors are uncoupled, the spring member(s) return the sealing member(s) to a position that closes the valve(s). Conventionally, each of the conduit, the interface member, the sealing member, and the spring member are distinct components adding cost and additional labor to the construction of a shutoff connector.

The information included in this Background section of the specification, including any references cited herein and any description or discussion thereof, is included for technical reference purposes only and is not to be regarded subject matter by which the scope of the invention is to be bound.

### SUMMARY

Implementations of fluid connectors having shutoff valves disclosed herein have an integrally formed valve component. For example, in some embodiments, the integrally formed valve component includes a spring portion that defines at least one fluid pathway. Additionally, the integrated valve component may include a sealing member and/or an interface member.

In some embodiments, the interface member may be formed as a single, integral component with the spring portion. Additionally, or alternatively, in some embodiments the sealing member may be part of the integrally formed valve component. In particular, when the integrally formed valve component is made of an elastomeric material (e.g., rubber) the sealing member may be formed as part of the spring member. In some embodiments, the sealing member may include surfaces of the spring member that are configured to form a seal.

Additionally, in some embodiments, the integrally formed valve component may include the spring portion and the sealing member without the interface member. In some embodiments, a plunger is provided separately from the integrated valve component and, in some respects, functions as an interface member.

A housing defining a cavity encapsulates the integral valve component to form one-half of a fluid conduit connector device. The housing and the valve component together form a portion of the flow pathway of the fluid connector. The cavity is external to a volume defined by the interior surfaces of the integral valve component. The housing may be sealed together with the integrally formed valve component in several different ways. For example, in one embodiment, the housing may be sealed to the integrally formed valve component using ultrasonic welding, hot-plate welding, chemical bonding, or by bolting the cover to the integrally formed component.

In some embodiments, the integral valve component is formed as a spring member. The spring member may be tapered, or may have other external surface shapes such as corrugations, fluted features, or the like. The spring member may be integrally formed with either or both of an interface member and a barbed end. The spring portion of the integral valve component may be shaped as a single helix, a double helix (or more), a stent (e.g., tube with apertures or fenestrations in the sidewalls), or other suitable shape. The apertures may have various different shapes, e.g., circles, squares, diamonds, and so forth. In some embodiments, the spring member tapers from a larger circumference near the barb to a smaller circumference near the interface member. The interior of the spring member forms a portion of a flow pathway with a lumen formed in the barbed end.

In some embodiments, a locking mechanism is provided to lock male and female connectors together. When the locking member is engaged, one or more integrally formed valves are open to form a fluid pathway therethrough. The locking member may be disengaged by depression of an actuator to allow for decoupling of male and female connectors.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention is provided in the following written description of various embodiments of the invention, illustrated in the accompanying drawings, and defined in the appended claims.

### BRIEF DESCRIPTION OF THE DRAWINGS

FIG. 1 is side elevation view of a female integrated valve component.

FIG. 2 is a side elevation view of a male integrated valve component

FIG. 3 is a cross-section view of the male and female integrated valve components of FIGS. 1 and 2, each having a housing for coupling and shown in an uncoupled and closed state.

FIG. 4 is an enlarged view of a portion of FIG. 3 detailing a sealing interface between the integral valve component and the housing of the female connector component.

FIG. 5 is a cross-section view of the male and female fluid conduit connectors including integrated valve components of FIGS. 1 and 2 in a coupled and open state.

FIG. 6 is an enlarged view of a portion of FIG. 5 detailing an interface between the female and male integrated valve components opening the valve members.

FIG. 7 is an isometric view of a second exemplary embodiment of a fenestrated, tapered, integrally-formed valve component for use in a shutoff valve of a fluid connector.

FIG. 8 is an isometric view of a third exemplary embodiment of a fenestrated, tapered, integrally-formed valve component for use in a shutoff valve of a fluid connector.

FIG. 9 is an isometric view of a fourth exemplary embodiment of a fenestrated, tapered, integrally-formed valve component for use in a shutoff valve of a fluid connector.

FIG. 10 is an isometric view of a fifth exemplary embodiment of a fenestrated, tapered, integrally-formed valve component for use in a shutoff valve of a fluid connector.

FIG. 11 is a side elevation view of a plunger that may be used with the integrally-formed valves of FIGS. 7-10.

FIG. 12 is a side elevation view of the plunger of FIG. 11 integrally-formed with the fenestrated valve of FIG. 7.

FIG. 13 is a top plan view of a fluid conduit connector with integrally formed valve components of FIG. 7.

FIG. 14 is a cross-section view of the fluid conduit connector of FIG. 13 taken along line 14-14 in FIG. 13.

FIG. 15 is an enlarged, isometric, cross-section view of a portion of the connector of FIG. 13 when assembled.

FIG. 16 is an isometric view of an exemplary embodiment of a multiple lumen connector.

FIG. 17 is an elevation view of the multiple lumen connector of FIG. 16 illustrating a connection structure for holding male and female components of the multiple lumen connector together.

FIG. 18 is an isometric, cross-section view of the multiple lumen connector of FIG. 16 taken along line 18-18 in FIG. 16.

FIG. 19 is an isometric view of a single lumen, pushbutton connector connected to a male bayonet connector.

FIG. 20 is an isometric view of the male bayonet connector with an integrated plunger that couples with the female pushbutton connector of FIG. 19.

FIG. 21 is an isometric, cross-section view of a portion of the male bayonet connector of FIG. 20 and a portion of the female pushbutton connector of FIG. 19.

FIG. 22 is an isometric, cross-section view depicting the male bayonet connector entering the female pushbutton connector.

FIG. 23 is an enlarged, isometric, cross-section view depicting the plunger of the male bayonet connector interfacing with the female pushbutton connector.

FIG. 24 is an enlarged, elevation, cross-section view depicting the male bayonet connector locked within the female pushbutton connector and displacing the integrated valve to allow fluid flow.

FIG. 25 is an isometric view of an inline connector system having a male connector and a female connector.

FIG. 26 is a cross-section view of the inline connector system of FIG. 25 taken along line 26-26 in FIG. 25.

FIG. 27 is an enlarged, isometric, cross-section view of the inline connector system depicting the male connector partially inserted within the female connector and the plunger of the female connector interfacing with the male connector.

FIG. 28 is an enlarged, isometric, cross-section view of the inline connector system with a depicting the male connector locked within the female connector and displacing the integrated valves to allow fluid flow.

FIG. 29 is an elevation view of an exemplary embodiment of a fenestrated, straight, integrally-formed valve component for use in a shutoff valve of a fluid connector.

FIG. 30 is an elevation view of an exemplary alternate embodiment of a fenestrated, straight, integrally-formed valve component for use in a shutoff valve of a fluid connector.

FIG. 31 is a cross-section view of an alternate embodiment of male and female fluid conduit connectors including integrated valve components of FIGS. 30 and 31 in a coupled and open state.

FIG. 32 is a cross-section view of the male fluid conduit connector of FIG. 31 taken along line 32-32 in FIG. 31.

FIG. 33 is a cross-section view of the male fluid conduit connector of FIG. 31 taken along line 33-33 in FIG. 34.

FIG. 34 is an isometric view of the male fluid conduit connector of FIG. 31.

FIG. 35 is a graph showing the change in length of an elastomeric tubular member (of 3 different materials) as disclosed herein over time.

FIG. 36 is a graph showing the percent change in length of an elastomeric tubular member (of 3 different materials) as disclosed herein over time.

### DETAILED DESCRIPTION

Implementations of a shutoff valve for use in inline fluid conduit connectors having integrally formed component parts to simplify the manufacturing process are disclosed herein. In particular, a shutoff valve is disclosed that integrates two or more traditionally separate component parts of the shutoff valve into a single integrated part. One integral component of the shutoff valve may be a spring portion provided to hold the shutoff valve closed. The shutoff valve may define a lumen and a fenestrated outer wall through which fluid may flow when the valve is opened. The spring portion may be configured to be compressed when two halves of the fluid connector are coupled together to open respective valves in each of the halves of the fluid connector and return to an extended position to close the valve when the two halves of the fluid connector are decoupled.

The spring portion may take multiple forms and may be integrally formed with one or more other parts of the shutoff valve. In one embodiment, the spring may be formed as a tapered helical feature with one or more spiral members. In some embodiments, the spring may be formed as a fenestrated tube. In some embodiments, the spring may take the form of a hollowed integrally formed valve with apertures extending through the walls of the integrally formed valve. The apertures may be shaped in one or more geometric shapes such as circles, ovals, triangles, parallelograms, and so forth. These, and other features, are described in greater detail below with reference to the drawings.

In some embodiments, the spring portion may extend between an interface member and a barb end. Additionally, in some embodiments, the spring portion may be rigidly attached to or integral with one or more of the interface members and the barb end, while in other embodiments, the spring portion may not be rigidly attached to or integral with one or more of the interface member and/or barb end. For example, if the spring portion is compression or cast molded, it may not be rigidly attached. However, if the spring portion is injection molded, it may be rigidly attached to or integrally molded with the barb and/or the interface member.

Implementations of shutoff valves may be formed of plastic (e.g., semi-rigid material such as acetyl), thermoplastic elastomers, or rubber. The shutoff valve may be molded by injection molding (e.g., if a plastic), reaction injection molding (e.g. if a thermoplastic), or by compression or cast molding (e.g., if a rubber), and/or other appropriate molding processes depending upon the material used. In one exemplary implementation using a plastic material, the entire barb and interface member can be molded as a single part. To make a seal, an O-ring may be seated adjacent the interface portion. The opposite end adjacent the barb may be sealed several ways when assembled into a connector such as sonic welding, hot plate, chemical bonding or even bolting it on with another elastomeric seal.

In an alternate implementation of a shutoff valve of made of an elastomer (e.g., rubber), all sealing surfaces are formed integrally into the part. For example, the interface portion may have a feature that resembles an O-ring that will seal in as a poppet. Similarly, a section adjacent the barbed end may be formed as a sealing surface. If a rubber seal is not rigidly attached to a barb, then the barb may be designed to seal onto the rear of the rubber valve. An interface may be formed from a separate hard plastic material forming the barb that attaches to and end of the rubber valve.

By integrally forming various component parts of the shutoff valves, the manufacturing process is improved. In particular, the integrated parts reduce the amount of time and money required for manufacture, as there are fewer overall parts and fewer steps required in the process.

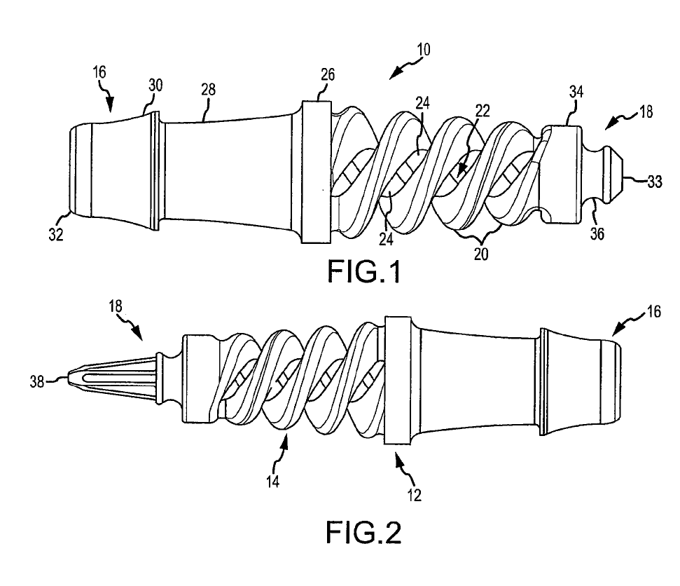

Turning to the figures and referring initially to FIG. 1, an exemplary embodiment of a female integrated shutoff valve 10 is illustrated. As its name suggests, the female integrated shutoff valve integrates several component parts of a standard shutoff valve and may be formed through a single process as a unitary member. The female integrated shutoff valve includes a tapered helical feature 14 that extends between a barbed end 16 and an interface member 18, functions as a spring member, and allows for fluid to flow therethrough and around.

The tapered helical feature 14 may include one or more helical structures 20 connected to interface member 18 and the barbed end 16. In one embodiment and as illustrated in FIG. 1, the tapered helical feature 14 may include two tapered helical members 20. The tapered helical members 20 may have a pitch and length such that they complete a desired number of rotations between interface member 18 and the barbed end 16. For example, each tapered helical member 20 may complete one or more turns.

The helical structures 20 maintain the interface member 18 at a distance from the barbed end 16 and may be compressed longitudinally when pressure is applied to the interface member 18. The helical structures 20 have a spring characteristic resulting from compression of the helical structures 20 and the elastic properties of the material from which the helical structures 20 are made. As such, when pressure is removed from the interface member 18, the compressed helical structures 20 longitudinally extend to return the interface member 18 to the original distance from the barbed end 16. As discussed in greater detail below, an integrally formed shutoff valve is closed when helical structures 20 are fully extended and open when they are compressed.

The tapered helical feature 14 tapers from a maximum diameter near the barbed end 16 to a minimum diameter near the interface member 18. In other embodiments, the helical structures 20 may be uniform in diameter (e.g., not tapered) between the barbed end 16 and the interface member 18. In still other embodiments, the helical structures may taper smaller from the interface member 18 to the barbed end 16.

The tapering of the tapered helical feature 14 may be achieved in a variety of ways. In one embodiment, the size of the helical structures 20 may be tapered such that the outer diameter of the helical feature 14 tapers. That is, the cross-sectional area of the helical structures 20 may be smaller near the interface member 18 than near the barbed end 16. In some embodiments, a volume 22 defined by the interior surfaces 24 of the helical structures 20 does not taper. Rather, the diameter of the volume 22 remains constant along the length of the helical feature 14. In another embodiment, the volume 22 may taper from the barbed end 16 longitudinally to the interface member 18. In such an embodiment (not shown), the size of the helical structures 20 may or may not also be tapered to provide for tapering of the tapered helical feature 14. For example, in one embodiment (not shown), the size of the helical structures 20 and the volume 22 defined by the structures 20 may both taper.

The barbed end 16 defines a lumen so that it may function as a conduit for fluids that flow through the integrally formed shutoff valve. The helical structures 20 are integrally formed with a lip 26 of the barbed end 16. The barbed end 16 may define one or more barb(s) 30 on its outer diameter that are tapered toward the terminal end 32 of the barbed end 16. The barb 30 allows for a rubberized hose, plastic tube, or other conduit suitable for fluid transport to be attached. Specifically, the tapered shape of the barb 30 allows for a conduit (not shown) to fit tightly over the barbed end 16 of the integrated shutoff valve 10 and holds the conduit in place or increases the difficulty of removing the conduit relative to installing the conduit on the female integrated shutoff valve. In some embodiments, the conduits may have interior barbs (i.e., barbs on the interior surface of the conduit) that interlock with the barb 30 of the female integrated shutoff valve and/or the conduits may be configured to shrink, for example, when heat is applied to prevent the conduit from easily being removed from the barbed end 16 of the female integrated shutoff valve.

The interface member 18 of the female integrated shutoff valve 10 has a contact surface 33 configured to contact a corresponding interface member of an opposing integrated valve member in a complementary or reciprocal connector component resulting in displacement of interface member 18 longitudinally towards the barbed end 16. The contact surface 33 may be concave or recessed to receive a male tip and prevent it from slipping off when coupled.

The interface member 18 may include a boss 34 to which the helical structures are integrally formed. Additionally, the interface member 18 includes a circumferential recess 36 for retention of sealing members. The recess 36 about the circumference of the interface member 18 allows for positioning of a sealing member for sealing when coupling integrally formed shutoff valves together. The recess 36 may be located about the interface members between the boss 34 and contact surface 33. The recess 36 holds the sealing member in place when coupling of the connector brings the integrally formed shutoff valves together and prevents the sealing member from being removed from the interface member 18 when decoupling connector and the integrally formed shutoff valves.

The female integrated shutoff valve 10, and other components described herein, may be made of a suitable material with a low yield such as acetyl, acetal, polyoxymethylene (POM), thermoplastic polyurethane (TPU), and similar materials, or elastomeric rubbers (e.g., ethylene propylene diene monomer (EPDM), nitrile rubber, styrene block copolymers, and so forth). The durometer of the elastomeric rubber materials may be tested and selected according to empirical analysis to achieve a desired resistance to force the spring quickly to make a seal but to allow for a relatively easy connection. Additionally, the tapered helical feature 14 and the other spring members described herein, e.g., the barbed end 16 and the interface member 18 of the integrated shutoff valve 10, may be created integrally through a suitable process. For example, the integrated shutoff valve 10 may be created through a molding process such as compression molding, casting, reaction injection molding, liquid silicone rubber molding for rubber materials, injection molding (e.g., two and three shot processes for both plastic and rubber). Additionally, a milling process may be implemented such as computer numerical control (CNC) milling or rapid prototyping.

Additionally, while the tapered helical feature 14, the barbed end 16, and the interface member 18 of the female integrated shutoff valve 10 may be created integrally in a single process, in other embodiments, they may be created in separate processes. Further, in other embodiments, the tapered helical feature 14 may be created integrally with one of the barbed end 16 or with the interface member 18, but not both.

FIG. 2 illustrates a male integrated shutoff valve 12. The male integrated shutoff valve includes a tapered helical feature 14, a barbed end 16, and an interface member 18, similar to the female integrated shutoff valve 10 of FIG. 1. A contact surface 38 of the interface member 18 on the male integrated shutoff valve 12 may extend or protrude further from the interface member 18 than the contact surface 33 of the female integrated shutoff valve 10. In one embodiment, the contact surface 33 of the female integrated shutoff valve (FIG. 1) may be concave to receive the contact surface 38 of the male integrated shutoff valve 12. In other embodiments, the contact surfaces 33 and 38 may have the same form. For example, in one embodiment, the contact surfaces 33 and 38 may each be flat.

It should be appreciated that although the integrated shutoff valves 10 and 12 have been illustrated and described as fully integral components, in other embodiments one or more of the barbed end 16, the tapered helical feature 14, and/or the interface member 18 may be separately created and subsequently coupled to the other parts. Additionally, in some embodiments the tapered helical feature 14 may be made of a material providing different elastomeric properties as compared to the materials used for the other parts. The elastomeric properties allow the tapered helical feature 14 to function as a spring. Additionally, the integrated shutoff valves may be formed separately but joined together using adhesives or other processes such as solvent bonding, ultrasonic welding, and so forth. Generally, a low compression rubber set may be implemented for the spring portions. In some embodiments, for example where the application calls for a quick (i.e., short duration) connection and release of the connector, a low yield plastic may be implemented for the spring portions.

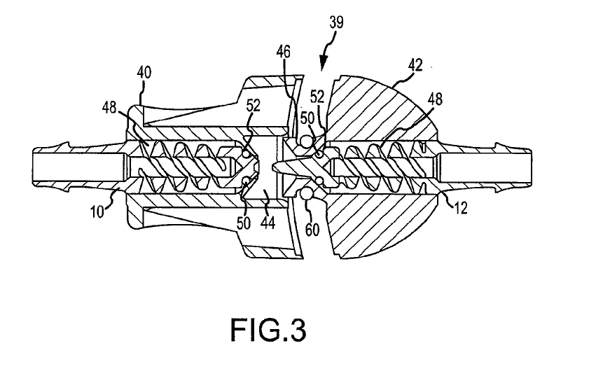

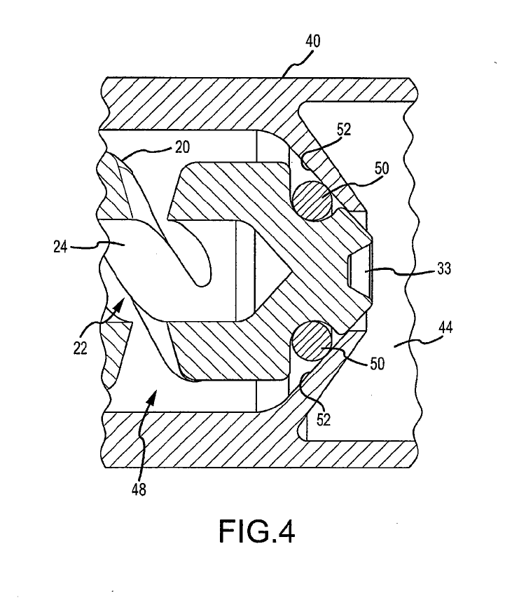

A cross-section view of an exemplary fluid connector 39 with integrally formed shutoff valves 10 and 12 is presented in FIGS. 3 and 4. As illustrated, female and male housings 40 and 42, respectively, cover portions of the integrated shutoff valves 10 and 12 to complete male and female halves of the fluid connector 39. The housings 40 and 42 may be made of a plastic material formed through a molding or etching process and the integrated shutoff valves 10 and 12 fit within the cavities defined by the housings 40 and 42. In other embodiments, the housings 40 and 42 may be formed directly over the integrated shutoff valves 10, 12 through an overmold process. The housings 40 and 42 are configured to couple together to engage the male and female integrated shutoff valves 10 and 12. The female housing 40 may define a receiving cavity 44 for receiving a protruding member 46 of the male housing 42 when coupling the fluid connector 39 together.

As noted, the female and male housings 40 and 42 each define interior cavities 48 that encapsulate the tapered helical features 14. The tapered helical features 14 press sealing members 50 against inner surface 52 of the cavities 48. The sealing members 50 are positioned about the interface members 18 of the female and male integrated valve members 10 and 12. In one embodiment, the sealing members 50 are rubber O-rings. In some embodiments, the sealing members 50 may be assembled onto the end of the tapered helical features 14. In other embodiments, the sealing members 50 may be molded into the end of the tapered helical features 14 (for example, using a 2 and/or 3 shot molding process) or may be integral features of the tapered helical features 14.

Pressure supplied by the spring force of the tapered helical features 14 and, in some embodiments, fluid within the cavities 48, holds the tapered helical features 14 and the sealing members 50 against the inner surfaces of the cavities 48 to prevent the flow of fluid out of the cavities 48. In another embodiment, the sealing members 50 are elastomer overmolds on the interface members 18. In yet another embodiment, an elastomer/rubber cap or molded material having a more elastic durometer than the interface members 18 covers the interface members 18. Such elastomer overmolds and caps may have a durometer such that they deform when pressed by the spring force of the helical features 14 against the inner surface 52 of the cavities 48 to create a seal.

In some embodiments, one or more additional sealing and/or coupling members may be provided to secure the two halves of the fluid connector 39 together and/or to prevent fluid from escaping the fluid connector 39. For example, as illustrated, an additional sealing member 60 may be provided about the protruding member 46 of the male housing 42. The additional sealing member 60 creates a seal between the female and male housings 40 and 42 and provides an interface fit between the two halves of the fluid connector 39 to hold the two halves together. More specifically, the sealing member 60 provides a seal between the cavity 44 of the female housing 40 and the protruding member 46 of the male housing 42 to prevent leakage of fluid from the fluid connector 39 when the integrated components 10 and 13 are in open positions and may provide sufficient friction to hold the fluid connector 39 together. Other mechanical latch features (not shown) may further be used to hold the male and female halves of the fluid connector 39 together.

In other embodiments, sealing and coupling members may include one or more ridges (not shown) integral with the interior surface of the cavity 44 of the female housing 40 and the outer surface of the protruding member 46 of the male housing 42. The ridges may be concentric and have a size that prevents easy uncoupling of the two halves of the shutoff valve without making it difficult to couple them together. In yet another alternative embodiment, the protruding member 46 of the male housing 42 may be slightly tapered such that as it is inserted into the receiving cavity 44 of the female housing 40, the friction increases to hold the two halves of the fluid connector 39 together.

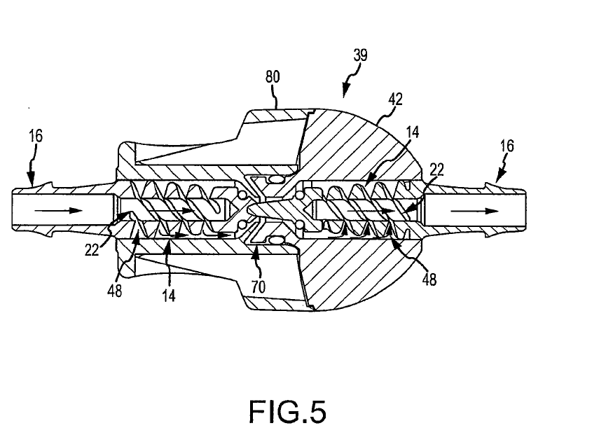

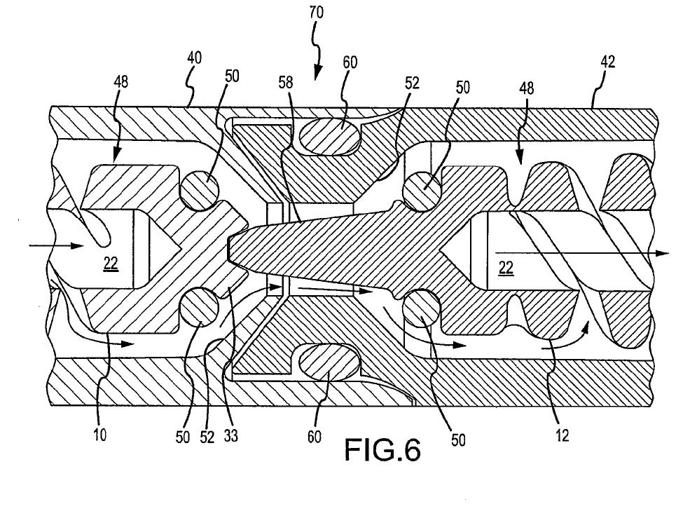

FIGS. 5 and 6 illustrate the female and male integrated shutoff valves 10 and 12 in an interfaced position contracting the tapered helical features 14 longitudinally to open the integrated shutoff valves 10, 12 within the fluid connector 39. When the integrated shutoff valves are opened, fluid may flow through the fluid connector 39 in either direction (i.e., flow may proceed from the male integrated shutoff valve 12 to the female integrated shutoff valve 10, or vice-versa). Specifically, fluid may flow through the interior of the barbed end 16 of the female integrated shutoff valve 10 into and through the tapered helical feature 14, into the cavity 48 of the female housing 40, through the interface 70 of the male and female integrated shutoff valves 10 and 12, into the cavity 48 of the male housing 42, through and into the tapered helical feature 14 and out the barbed end 16 of the male integrated shutoff valve 12.

Should the two halves of the fluid connector 39 become decoupled, the tapered helical features 14 extend in their respective, opposing directions of bias to close the integrated shutoff valves 10, 12 within the cavities of the respective female and male housings 40, 42 of the fluid connector 39. Thus, the shutoff valve 39 is only open when pressure is applied to the interface members 18 to displace them longitudinally and thus remove the seal between the sealing members 50 and the covers 40 and 42.

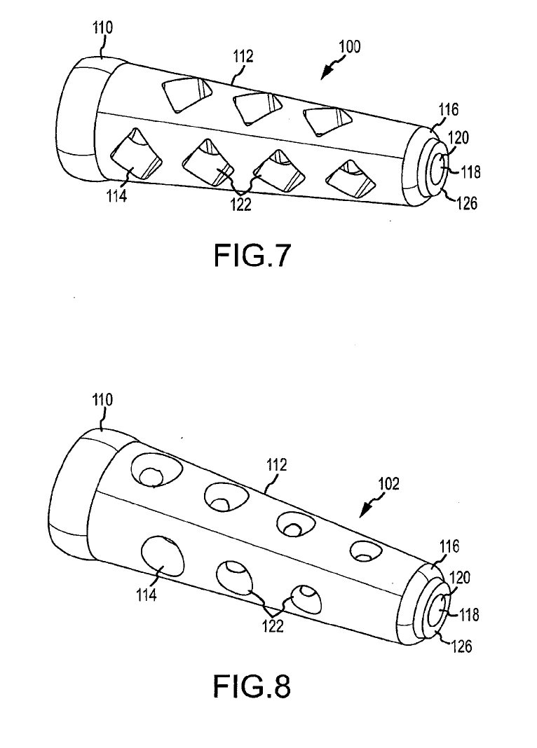

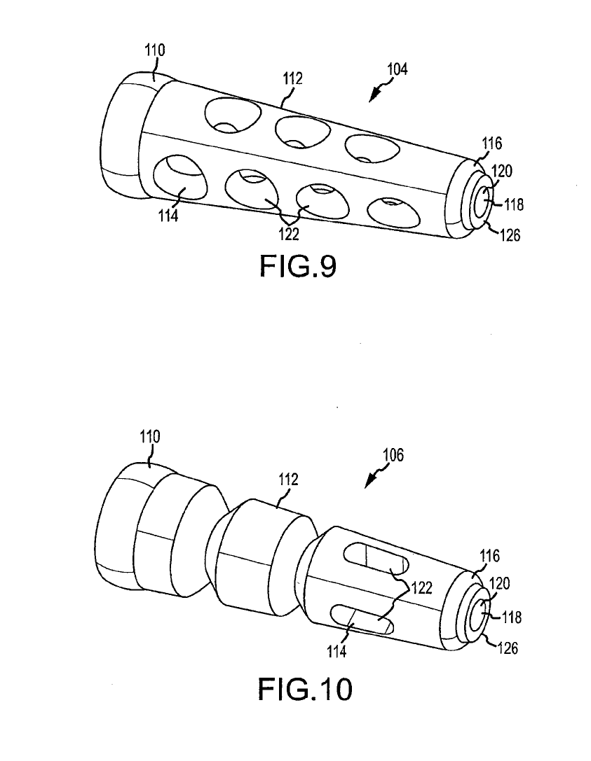

FIGS. 7-10 illustrate various different designs of integrally formed valves 100, 102, 104, 106 that may be implemented as an integrated valve component or part of an integrated valve component of a shutoff valve of a fluid connector in accordance with exemplary embodiments. Specifically, the integrally formed valves 100, 102, 104, 106 each are a fenestrated tubular member. The fenestrated tubular members provide the functionality of multiple component parts of a tradition shutoff valve. For example, the fenestrated tubes define apertures to allow the fenestrated tubular member to be compressed to a shorter length and resiliently return to longer length than when compressed and to provide a fluid flow pathway, as discussed in greater detail below. This type of valve may be used with different housing structures than are shown herein. Also, the integrally formed valve members used in a connector structure need not be identical to one another in both halves of the housing.

Each integrally formed valve 100, 102, 104, 106 may have molded into it, a rear sealing feature 110, a spring body for flex 112, a fluid passage 114 to allow flow therethrough, a front sealing surface 116, and an alignment tip 118 with a front pocket 120. The rear sealing feature 110 may be a circumferential protrusion in the surface of the integrally formed valve that forms a seal at the rear of a connector in which the integrally formed valve is implemented. In some embodiments, the integrally formed valve 100, 102, 104, 106 may be overmolded onto a barb end such that the barb end may be considered part of an integrated component. In other embodiments, the barb end is independent from the integrated valve component. The barb may be coupled to a connector in a suitable manner and the rear seal 110 may help prevent fluid leakage from occurring around the outside of the barb.

The spring body 112 may include apertures 122 formed in a radial orientation in the sidewalls of the integrally formed valves 100, 102, 104, 106 and placed or positioned around the body 112 to allow the integrally formed valves 100, 102, 104, 106 to compress, for example axially compress, to provide low stress and minimal fatigue when compressed. The apertures may be arranged longitudinally in staggered positions with respect to circumferentially adjacent apertures 122, or alternately arranged along common latitudinal circumferences. The geometry of the apertures 122 may take different forms such as squares, circles, diamonds, or other shapes.

In addition to providing spring functionality, the apertures 122 provide a fluid flow pathway. For example, fluid may enter through an inner diameter of the rear sealing surface 110 and pass through the apertures 122 as the flow moves towards and around the front sealing surface 116.

The front sealing surface 116 may be a surface along a curved portion of the integrally formed valves that when in a resting or closed state inside the connector abuts a portion of the housing to provide a seal to prevent the flow of fluid through the valve. In other embodiments, the front sealing surface 116 may be a circumferential protrusion similar to the rear sealing feature. The seal provided by the front sealing surface prevents fluid from leaking out of the valve when the valve is closed.

The alignment tip 118 with the front pocket 120 serves to hold and align a plunger and/or an opposing integrally formed valve. In one embodiment the pocket 120 may be a reversed tapered blind hole to hold a plunger. Having a reverse taper on the plunger and the pocket allows for the plunger to serve the purpose of pulling the darts into the sealing surface during decoupling. In other embodiments, the pocket 120 may have a generally cylindrical shape or other suitable shape to receive a plunger.

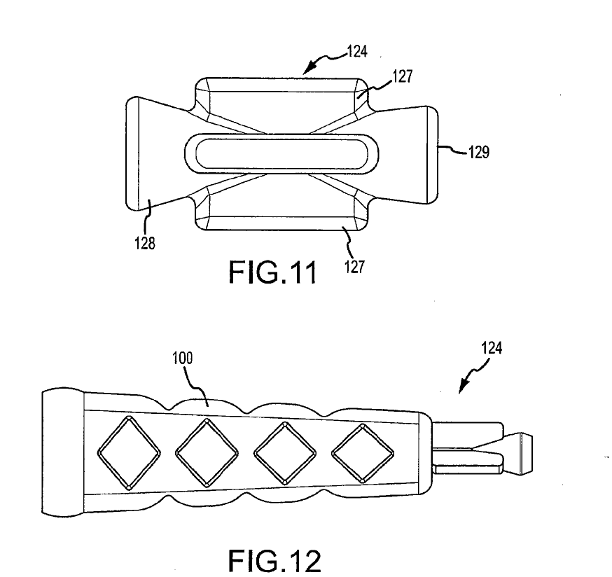

FIG. 11 illustrates an exemplary plunger 124. The plunger 124 may be implemented as a separate component in embodiments where the spring body 112 (and/or integrated valve) is made of a soft elastomeric material, such as materials having approximately 80 Shore A hardness range and below. In other embodiments, with elastomeric materials of approximately 80-90 Shore A hardness, the plunger may be molded integrally with the tip of an integrated valve, as shown in FIG. 12.

Referring again to FIG. 11, the plunger 124 may have a generally hourglass shape to create a dovetail connection in the pocket 120 of the alignment tip 118. In particular, the hourglass shape may include a first end 128 that tapers larger outwardly from a center of the plunger. In some embodiments, the plunger 124 may include a second end 129 that does not taper as sharply outwardly from the center of the plunger. In some embodiments, both ends may be substantially cylindrical in shape or may be formed with any other desirable cross-sectional shape (e.g., square, hexagonal, etc.).

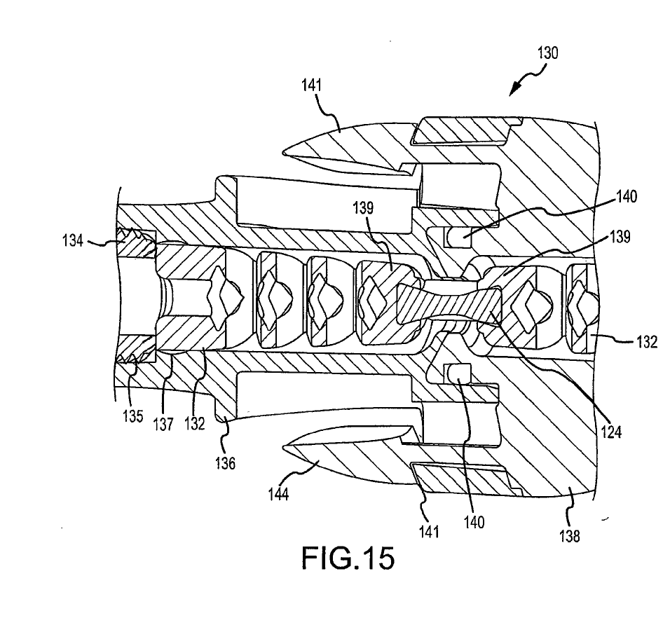

In embodiments where the first end 128 has a larger taper than the second end 129, the first end may be configured to be permanently installed within the pocket 120. That is, the first end 128 may be installed in the pocket 120 and not removed through use, whereas the second end 129 is removeably installed during use. In some embodiments, the first end 128 is permanently installed in a female side. This keeps the connector hidden inside the female orifice so that in the event the connector is placed face down a on a hard surface the flow will not be opened. (See FIGS. 14 and 15.) That is, the plunger is protected from contact with the hard surface and potential displacement from the female connector housing which could open the seal.

The plunger 124 may include a flow path and centering section that may include one or more fins 127 extending longitudinally and outwardly therefrom. The flow path and centering section allows fluid to flow when the connector is connected. The one or more fins 127 help to align the integrated valves and aids in keeping an opposing integrated valve centered to the orifice. In some embodiments, the alignment is achieved by the one or more fins 127 abutting a portion of a housing. In some embodiments a receiving feature may be provided in the housing to receive the on or more fins 127, thereby helping to align opposing integrated valves.

An exterior surface 126 around the pocket 120 may be tapered slightly inward so that the plunger 124 may be guided and centered into the pocket. The pocket 120 and plunger 124 may also be configured to pull the integrally formed valves 100, 102, 104, 106 into a position to close the valve and center the integrally formed valve when the connector is being disconnected. That is, the shape of the pocket 120 and the plunger 124 on one end of the connector may be such that when pulling the connector apart, the pocket 120 holds onto the plunger 124 for a short distance thereby pulling the spring member 112 and front-sealing surface 116 into a closed position before the plunger 124 releases from the pocket 120.

The integrally formed valves 100, 102, 104, 106 may be injection molded or compression molded of an elastomeric material, as discussed above. The integrally formed valves are not limited in size or shape or cross-sectional geometry and may be used in a connector in which one side may have a shutoff valve and the other side does not. As such, the integrally formed valves are designed to function in a variety of connector applications.

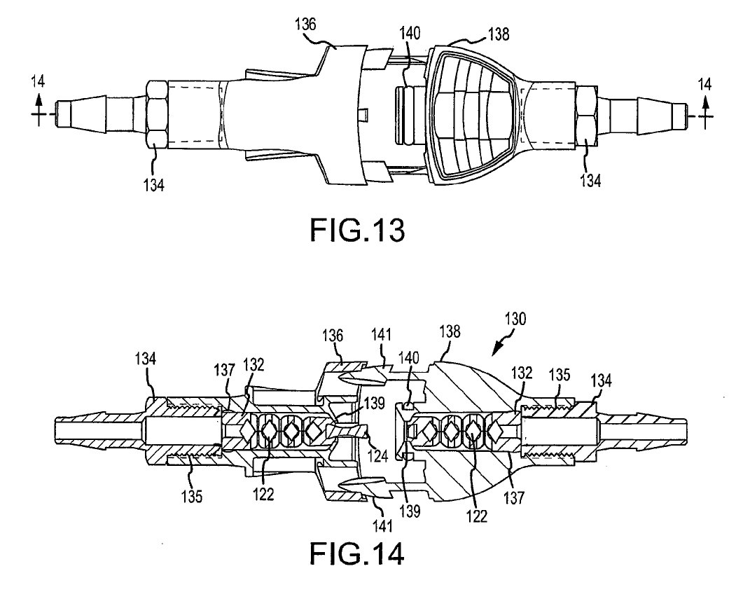

FIGS. 13 and 14 illustrate male and female connectors implementing the integrated valve 100. FIG. 14 illustrates, in cross-section, a connector 130 implementing integrally formed valves 132. The integrally formed valves 132 have been coupled to barbed ends 134 to help enable coupling of the connector 130 into a fluid pathway. Female and male housings 136 and 138 are provided to encompass the integrally formed valves 132. In some embodiments, the barbed ends 134 may include a threaded region 135 for coupling of the barbed ends to their respective housing 136 and 138. Additionally, a hexagonal (or other shaped) head may be provided to facilitate the attachment of the barbed ends to the housing 136, 138. In other embodiments, other features may be provided to facilitate the attachment of other components. For example, concentric ridges may be provided for attachment of the barbed ends and the housings in one embodiment, while in other embodiments, the barbed ends and housings may be coupled together through different modes. The rear-sealing feature 110 engages the housing to form a seal region 137 at the rear of the housing near the barbed end 134. A front-sealing feature 116 engages the housing to form seal region 139 at the front of the housing near the interconnection portion of each housing member. These seal regions of each integrally formed valve 132 create a seal with their respective housings 136, 138. An additional sealing member 140, e.g., an O-ring, is provided to form a seal between the two housings 136 and 138 when the housings are coupled together. The housings 136 and 138 may be configured to fit together and be held together. As such, latches, ridges, barbs, hooks, indentations, or other interlocking features 141 may be provided to couple the housings together in a complementary manner. Additionally, as illustrated, a plunger 142 is provided with one of the integrally formed valves.

FIG. 15 illustrates an enlarged section of the connector 130 of FIG. 11 when assembled. Specifically, the interlocking features 141 of the housings 136 and 138 are shown interlocked and the plunger 124 is coupled with and causing contraction of both integrally formed valves 132 thereby causing the front-sealing surfaces 139 to displace and open the valves 132 for fluid flow.

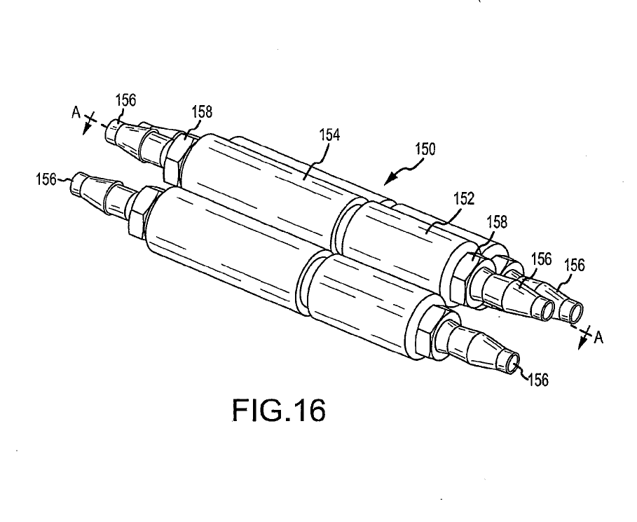

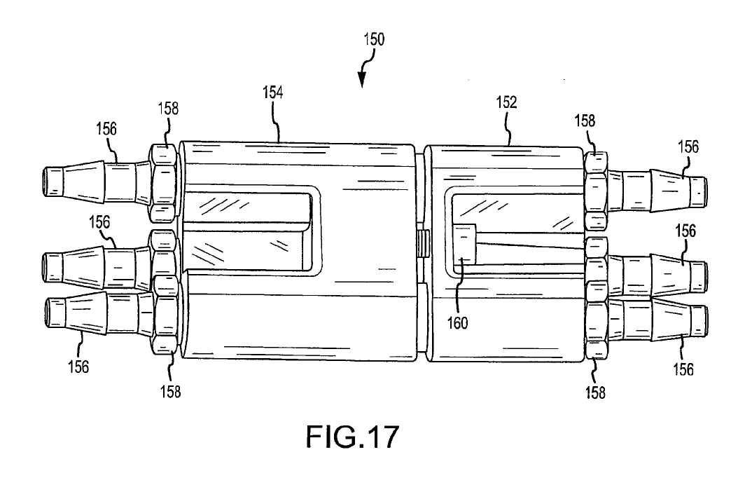

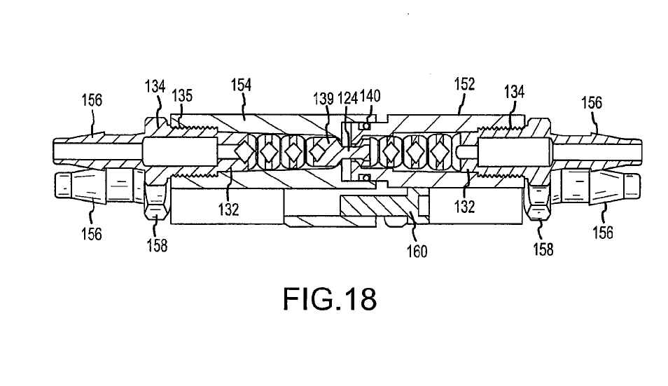

Multiple pathway connectors may be created by creating housings configured to house multiple integrally formed valves and barbed ends. FIGS. 16, 17 and 18 illustrate an exemplary embodiment of a multiple pathway connector 150 having housings 152 and 154 configured to house three unique fluid pathways. It should be appreciated that housings may be provided for any number of fluid pathways and that the embodiment described herein is an example. FIG. 16 is an isometric view, FIG. 17 is a bottom view and FIG. 18 is a cross-section view of the multiple pathway connector 150. Each fluid pathway includes a pair of integrally formed valves and barbed ends 156 as well as a plunger and a sealing member. Each of the various parts performs the same functions as describe above. As illustrated in FIGS. 16 and 17, a hexagonal (or other shaped) head 158 may be provided to facilitate attachment of barbed ends 156 to the housings 152 and 154 via threads on the barbed ends, as discussed above.

Additionally, the housings 152 and 154 may be coupled together in multiple different ways. For example, the housings 152 and 154 may be configured to snap together using hooks, barbs, ridges, indentations, or other complementary interlocking features integrally formed within the housings, as described above. Alternatively, an external coupling device, for example, a screw, bolt, and/or a latching mechanism may be provided to hold the housings 152 and 154 together. FIG. 17 illustrates the use of a bolt 160 to secure the housings 152 and 154 together. Additionally, in some embodiments, one or more sealing members may provide a seal between the housings 152 and 154 (e.g., similar to sealing member 140 in FIGS. 14 and 15) and may be configured to provide an interference coupling between the housings 152, 154.

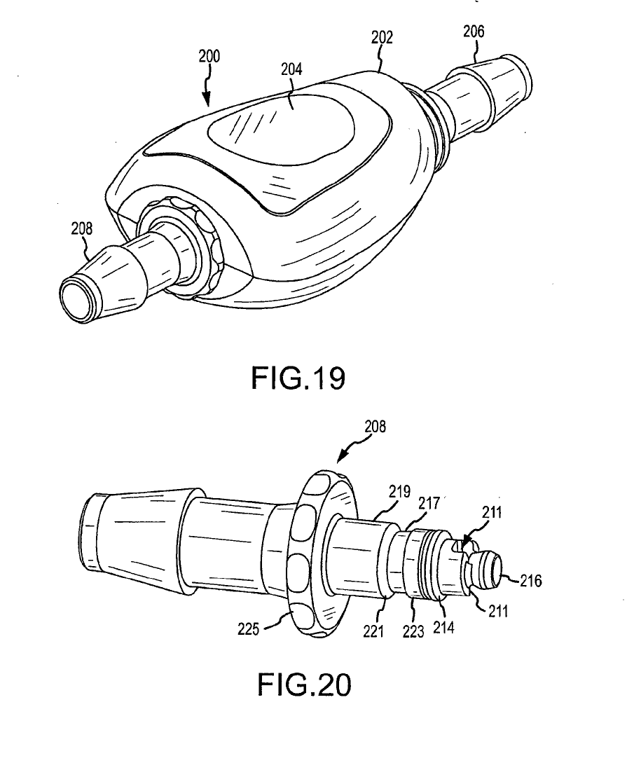

The integrated valves may be implemented in connectors with that provide for attachment and detachment using a push button or other actuator type device. In particular, FIGS. 19-24 illustrate an exemplary embodiment of a pushbutton, inline fluid connector 200 that has a single valve. The pushbutton connector 200 includes a housing 202 having a pushbutton 204. The housing 202 may be configured with an integral or detachable first barbed fitting 206 on one end. The housing 202 may also be configured to receive a male bayonet connector 208. The bayonet connector 208 may include features to displace an integrated valve 210 housed within the housing 202 to open the valve 210 and create a fluid pathway that extends through the bayonet connector 208 and the pushbutton connector 200, including the barbed fitting 206.

FIG. 20 illustrates the male bayonet connector 208. The bayonet connector 208 includes a sealing member 214, which in some embodiments may take the form of an O-ring. Additionally, the bayonet connector 208 includes an interference member 216 that extends outward from a proximal or insertion end and is configured to enter into the housing 202 and interface with the integrated valve 210 to displace and thereby open the integrated valve 210. In particular, the interface member 216 may be configured to be positioned within a pocket 218 of the integrated valve 210. In some embodiments the interface member 216 and the pocket 218 may be reversed tapered so that the pocket 218 holds the interface member 216 and, during decoupling, the interference member pulls the integrated valve 210 into a position that seals the cavity 214. Additionally, in some embodiments, the interface member 216 may be tapered to facilitate the entry into the pocket 218 and also to aid in aligning the bayonet connector 208 within the housing 202. The interface member 216 may be coupled to, or integrally formed with, the bayonet connector 208 to while providing for a fluid pathway into the lumen of the bayonet connector 208. In particular, apertures 211 may be provided between the interface member 216 and the bayonet connector 208 through which fluid may flow. The apertures 211 may be located between the sealing member 214 and the interface member 216.

The bayonet connector 208 may also define a locking channel 217 that circumscribes the outer surface 219 of the bayonet connector 208. In particular, in some embodiments, the locking channel 217 may have a tapered wall 221 and a squared wall 223. In other embodiments, both walls may be squared or tapered. The bayonet connector 208 may also include a grip feature 225 that may serve as a stop to prevent further insertion of the bayonet connector 208 into the housing 202. Additionally, in some embodiments, the grip feature 225 may be used as a finger grip to aid a user when coupling and/or decoupling the bayonet connector 208 from the pushbutton connector 200.

The pushbutton 204 may generally be a displaceable portion of the housing 202 that is linked to or integral with a locking member 203. The locking member 203 may be configured to secure the bayonet connector 208 within the housing 202. Generally, the locking channel 217 may have a shape that corresponds to and interfaces with the locking member 203. In particular, the locking member 203 may be configured with a receiving side 205 that may be tapered to allow insertion of the bayonet connector 208 and a locking side 207 that may be squared or more acutely tapered than the receiving side 205 to interface with the channel 217 and prevent the male bayonet connector 208 from being easily removed. The locking member 203 and the button 204 may be spring loaded or otherwise biased to a locking position from which they may be displaced to facilitate the receiving and removing of the bayonet connector 208 into the housing 202.

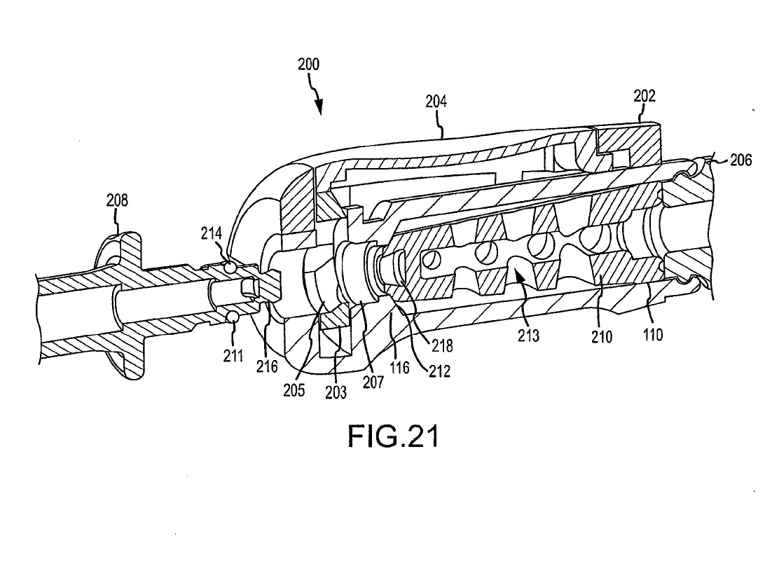

FIG. 21 is a cross-section view of the pushbutton connector 200 with the bayonet connector 208 decoupled from the housing 202. As shown, the housing 202 encapsulates an integrated valve 210. The integrated valve 210 may take the form of one of the embodiments described above (e.g., integrally formed valve 102). A front sealing member 118 of the integrated valve presses against an interior wall 212 of the housing 202 to seal a front portion of an interior cavity 213 of the housing. A rear sealing member 216 of the integrated valve 210 seals the rear portion of the interior cavity 214.

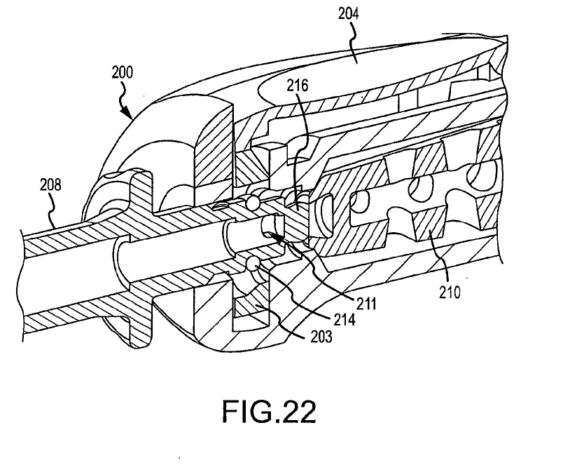

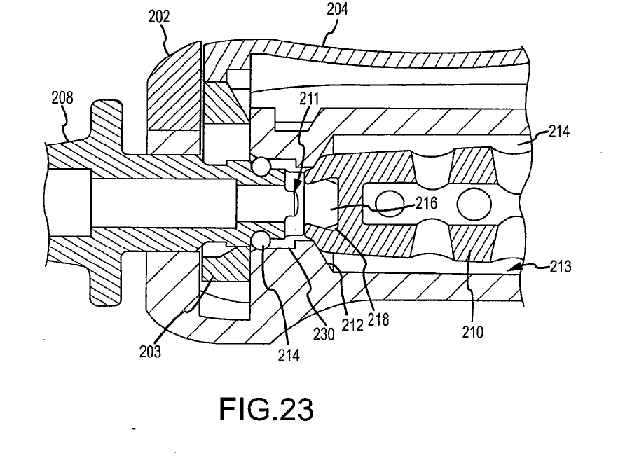

FIG. 22 illustrates the bayonet connector 208 partially inserted within the pushbutton connector 200, but not in a locked position. The locking member 203 and button 204 are displaced downward by the force of the bayonet connector 208 as it enters the housing 202. The interface member 216 is not pressing against the integrated valve 210 so the valve 210 remains sealed. FIG. 23 illustrates an intermediate step in the coupling and decoupling of the bayonet connector 208 into the housing 202. As shown, the interface member 216 is positioned within the pocket 218 of the integrated valve 210. The sealing member 214 of the bayonet connector 208 is in contact with a sealing surface 230 of the housing 202 thus creating a seal between the bayonet connector 208 and the pushbutton connector 200. The button 204 and locking member 203 are displaced to allow for further insertion of the bayonet connector 208 into the pushbutton connector 200. Additionally, the front sealing member 116 of the integrated valve 210 is in contact with the wall 212 of the housing 202 to seal the cavity 214 of the housing 202.

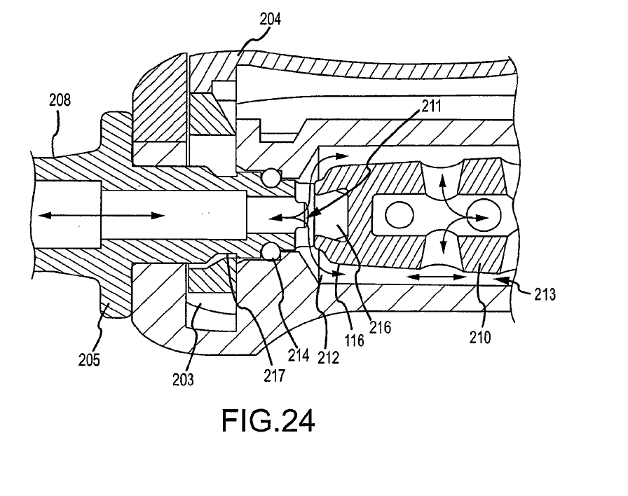

FIG. 24 illustrates the bayonet connector 208 in a locked position within the pushbutton connector 200. In the locked position, the bayonet connector 208 is fully inserted into the housing 202 and is held in place by the locking member 203. That is, the locking member 203 has engaged at least a portion of the locking channel 217 of the bayonet connector 208. Additionally, in the locked position, the integrated valve 210 is displaced and the front sealing member 118 is removed from the wall 212 such that the valve 210 is open, thereby allowing fluid to flow through the fluid pathway from the bayonet connector 208, through the pushbutton connector 200, to exit the barbed fitting 206, or in the opposite direction. In order to disconnect the bayonet connector 208 from the pushbutton connector 200, the button 204 may be depressed to remove the locking member 203 from the locking channel 217 and the bayonet connector 208 may be pulled out of the housing 202. As the bayonet connector 208 is withdrawn, the interface member 216 pulls the integrated valve 210 to close the valve 210 and the spring characteristics of the integrated valve 210 hold the valve 210 closed.

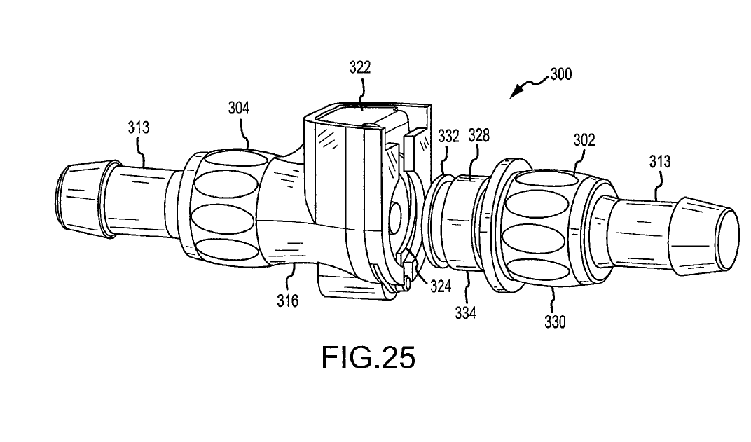

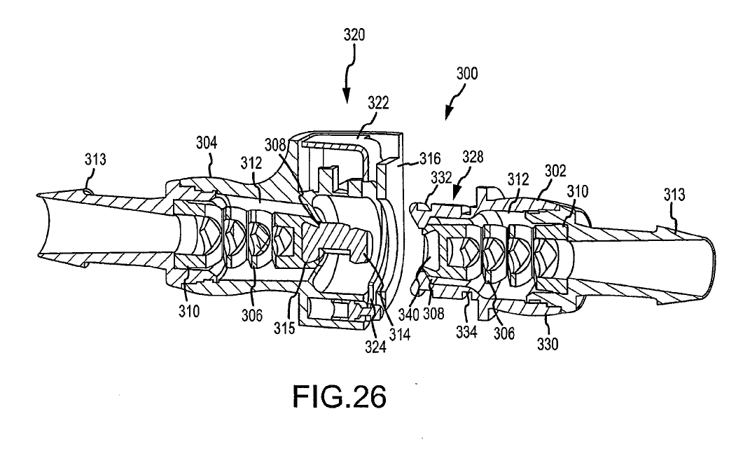

FIGS. 25-28 illustrate an embodiment of a inline fluid connector system 300. In FIG. 25, the connector system 300 is illustrated as having a male connector 302 and a female connector 304. FIG. 26 is a cross-section view of the connector system 300. Each of the male and female connectors 302, 304 includes an integrally formed valve 306, such as integrally formed valve 100. The integrally formed valves 306 each include a front sealing member 308 and a rear sealing member 310 to seal the interior cavities 312 of the male and female connectors 302, 304. Additionally each of the male and female connectors 302, 304 includes a barbed end 313 that forms a portion of a fluid pathway for the connector system 300 and is designed to connect with an end of a length of fluid tubing.

A plunger 314 may be coupled to the integrally formed valve 306 of the female connector 304. The plunger 314 may be reversed tapered and may be positioned within a pocket 315 of the integrally formed valve 306 of the female connector 304. A housing 316 of the female connector 304 generally protects the plunger from incidental contact to prevent accidental opening of the valve.

Additionally, the female connector 304 includes a locking mechanism 320. The locking mechanism 320 includes an externally accessible actuator 322 and a locking member 324. The actuator 322 and the locking member 324 may be integrally formed or may otherwise be coupled together so that the locking member 324 is displaced by movement of the actuator 322. In the embodiment shown, the locking member 324 is a guillotine latch plate that interfaces with a corresponding structure on the male connector 302.

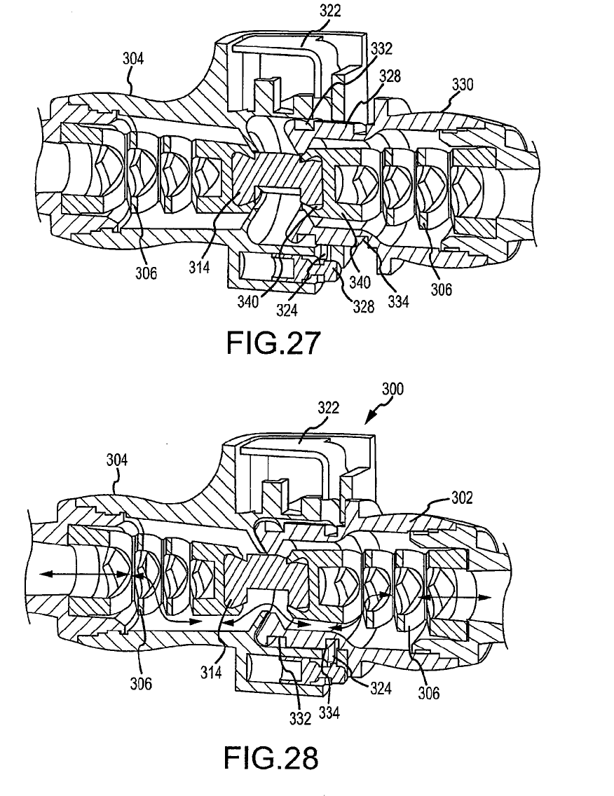

An engagement portion 328 of a housing 330 of the male connector 302 may be configured to be received by the female connector 304. FIG. 27 illustrates the engagement portion 328 of the male connector 302 entering the female connector 304. The engagement portion 328 of the male connector 302 may include one or more channels that circumscribe the housing 330. For example, in some embodiments a sealing channel 332 may be provided into which a sealing member, such as an O-ring (not shown) may be positioned. In another embodiment, the engagement portion 328 inserted into the female connector 304 may create an interference seal such that fluid does cannot pass through the interface between the male and female connectors 302, 304.

Additionally, a locking channel 334 may be provided. The locking channel 334 may be shaped to receive a portion of the locking member 324. As such, the locking member 324 and the locking channel 334 may have complimentary shapes. For example, the locking channel 334 may be a relief cut that coincides with the shape of the locking member 324. In some embodiments, the locking channel and locking member may each have squared or nearly squared edges. In another embodiment, one or more edges may be beveled or tapered.

As shown in FIG. 27, the plunger 314 is received into a pocket 340 of the integrally formed valve 306 of the male connector 302. In the intermediate position illustrated in FIG. 27, the actuator 322 is pushed downward, as is the locking member 324 to allow the male connector 302 to enter the female connector 304. The front sealing members 308 of the integrally formed valves 306 keep the valves 306 sealed closed.

In FIG. 28, the engagement portion 328 of the male connector 302 is fully inserted into the female connector 304, thereby displacing the front sealing members 308 and opening the valves 306 and creating a fluid pathway that is continuous between the barbed ends 313. Additionally, the locking member 324 engages the locking channel 334 to secure the male and female connectors 302, 304 together. In order to decouple the male and female connectors 302, 304, the actuator 322 is depressed to disengage the locking member 324 from the locking channel 334.

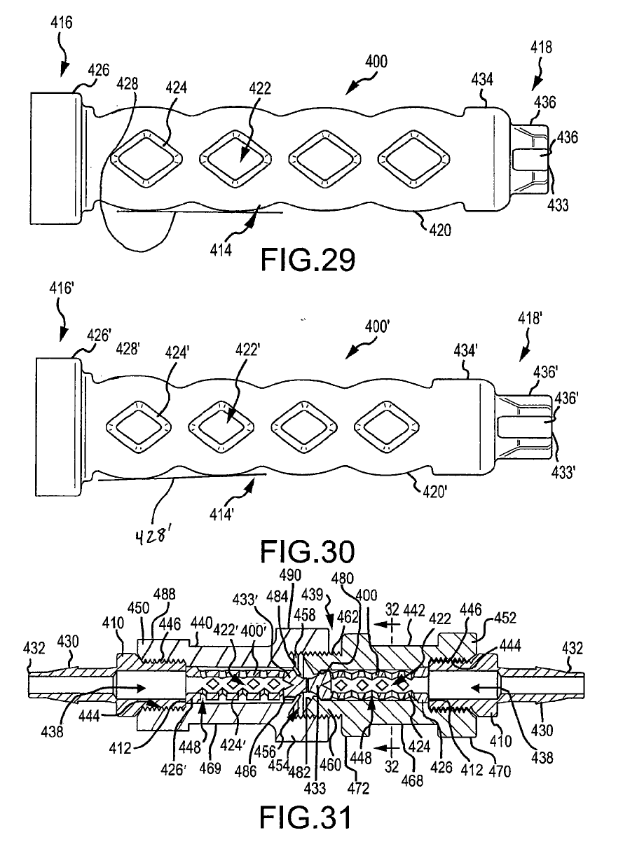

FIGS. 28 and 29 illustrate exemplary alternative designs of integrally formed valves 400, 400′ that may be implemented as an integrated valve component or part of an integrated valve component of a shutoff valve of a fluid connector. The integrally formed valves 400, 400′ are each a fenestrated tubular member. The fenestrated tubular members provide the functionality of multiple component parts of a tradition shutoff valve. For example, the fenestrated tubes define apertures to allow the fenestrated tubular member to be compressed and return to its original shape and to provide a fluid flow pathway, as previously discussed above.

Each integrally formed valve 400, 400′ has molded into it, a rear sealing feature 426, 426′, a spring body 420, 420′ for flex, apertures 424, 424′ forming part of a fluid passage 422, 422′ to allow flow therethrough, a front sealing surface 434, 434′, and an interface tip 433, 433′. The rear sealing feature 426, 426′ may be a circumferential protrusion in the surface of the integrally formed valve that seals at the rear of a connector in which the integrally formed valve is implemented. In this exemplary implementation, the body 420, 420′ of the valve 400, 400′ has a straight, tubular design from the base end 416, 416′ to the tip end 418, 418′, although the rear sealing feature 426, 426′ is of a larger diameter than the intermediate section 414, 414′ of the spring body 420, 420′ and the tip end 418, 418′ is of a smaller diameter than the intermediate section 414, 414′.

In some embodiments, the integrally formed valve 400, 400′ may be overmolded onto a barb end such that the barb end may be considered part of an integrated component. In other embodiments, the barb end is independent from the integrated valve component. The barb may be coupled to a connector in a suitable manner and the rear seal 426, 426′ may help prevent fluid leakage from occurring around the outside of the barb.

The spring body 420, 420′ may include apertures 424, 424′ formed in a radial orientation in the sidewalls of the intermediate section 414, 414′ of the integrally formed valves 400, 400′ and placed around the spring body 420, 420′ to allow the integrally formed valves 400, 400′ to compress axially (for example, similar to a “Z”-type spring) to provide low stress and low or minimal fatigue when compressed. The apertures 424, 424′ may be arranged longitudinally in staggered positions with respect to circumferentially adjacent apertures 424, 424′, or alternately arranged along common latitudinal circumferences. The geometry of the apertures 424, 424′ may take different forms such as squares, circles, diamonds, or other shapes. Additionally, a length of the fenestrated tube adjacent the base end 416 in FIG. 29 may be formed having sidewalls extending along the length of the tube that do not taper from the base end towards the mid-point of the length of the tube. For example, peaks of each curved sidewall feature form a line 428 parallel with the longitudinal axis of the tube. Alternatively, as shown in FIG. 30, a length of the fenestrated tube adjacent the base end 416′ may be formed with a taper at the rear end (represented by line 428′). For example, the peaks of each curved sidewall feature form a line 428′ angling relative to the longitudinal axis from the base 416′ towards the mid-point of the length of the tube. This taper may extend along a variety of lengths of the tube, and typically does not extend beyond the mid-point of the length of the tube. In the embodiment shown in FIG. 30 the taper extends to the second peak from the base 416′, and may extend less. The length of the tube beyond the taper may have parallel sidewalls as in FIG. 29, or may have tapered sidewalls opposite those near base end 416′. The taper provides a structural benefit to strengthen the portion of the fenestrated tubular member that is tapered and reduce possible lateral movement when compressed, and thus lessen the chance of the body binding with or contacting the inner surface of the housing in which it is placed.

In addition to providing spring functionality, the apertures 422, 422′ provide a fluid flow pathway 422, 422′ in communication with a central lumen of the spring body 420, 420′. For example, fluid may enter through an inner diameter of the rear sealing surface 426, 426′ and pass through the apertures 424, 424′ as the flow moves towards and around the front sealing surface 434, 434′.

The front sealing surface 434, 434′ may be a surface along a curved portion at the tip end 418, 418′ of the integrally formed valves 400, 400′ that when in a resting or closed state inside the connector abuts a portion of the housing to provide a seal to prevent the flow of fluid through the valve 400, 400′. In one embodiment, the front sealing surface 434, 434′ abuts against and outflow orifice in the connector housing to prevent fluids from leaking or escaping from the housing. In other embodiments, the front sealing surface 434, 434′ may be a circumferential protrusion similar to the rear sealing feature 426, 426′. The seal provided by the front sealing surface 434, 434′ prevents fluid from leaking out of the valve 400, 400′ when the valve 400, 400′ is closed. The front sealing surface 434, 434′ should be rigid enough to resist warping or collapsing, but flexible or soft enough to maintain a seal.

The interface tip 433, 433′ in this exemplary implementation is preferably rigid. In this way all (or most of) of the deflection of the valves 400, 400′ can be transferred to and concentrated within the spring body 420, 420′. The interface tip 433, 433′ may be formed with longitudinal ribs 436, 436′ spaced circumferentially about the interface tip 433, 433′ in order to provide additional structural rigidity. Depending upon the length of the interface tip 433, 433′ and corresponding properties of the spring body 420, 420′, an appropriate compression set for the interface tip 433, 433′ can be designed.

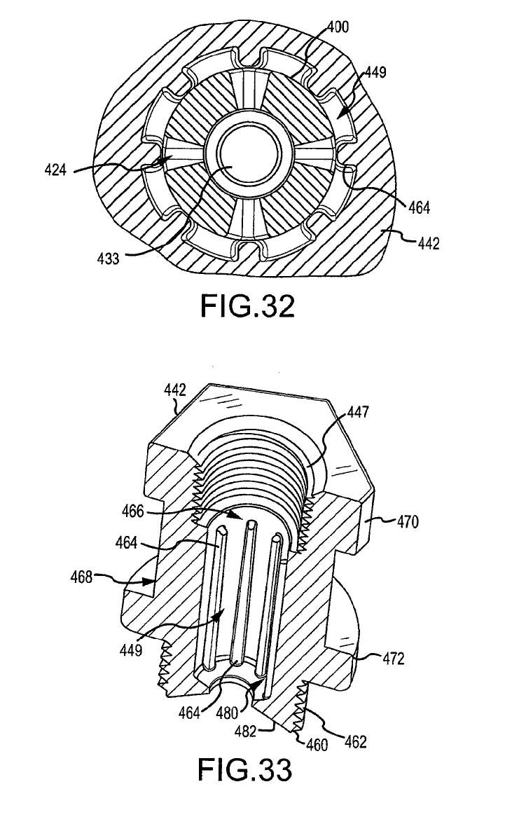

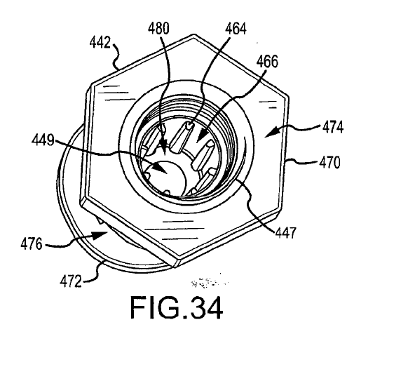

FIG. 31 depicts an exemplary implementation of a fluid connector system composed of a female connector 440 and a male connector 442. FIGS. 32-34 additionally depict the features of the male connector 442 in greater detail. Note, however, that many of the features shown only with respect to the male connector 442 can likewise be incorporated into the female connector 440.

Each of the female connector 440 and the male connector 442 is generally formed as a cylindrical housing and each defines a generally cylindrical lumen 448, 449, respectively. The male connector 442 has a hose connector end 452 and a coupling end 460. The female connector 440 similarly has a hose-connector end 450 and a coupling end 454. The hose-connector ends 450, 452 of each of the female and male connectors 440, 442 may each define a cylindrical cavity with threaded sidewalls 446, 447. Each of the hose-connector ends 450, 452 may also be formed as keyed flanges 470, 488, for example, as hexagonal flanges with six facets forming exterior sidewalls. The coupling end 454 of the female connector 440 may be formed as a positive stop flange 490 about the outer diameter that further defines a receiver orifice 456 with threading 458 on an inner diameter of the receiver orifice 456. The coupling end 460 of the male connector 442 may be formed as a combination of a positive stop flange 472 and a threaded nipple 462 extending longitudinally from the positive stop flange 472. A sidewall section 468 forming part of the lumen 449 may separate the keyed flange 470 from the positive stop flange 472. Similarly, a sidewall section 469 housing part of the lumen 448 may separate the keyed flange 488 from the positive stop flange 490 on the female connector 440.

An inner end wall 480 forms the end of the lumen 449 in the threaded nipple 462 of the male connector 442. The inner end wall 480 may be formed as a flange with a chamfered edge extending radially inward to decrease the diameter of the lumen 449. Opposite the inner end wall 480, an outer end wall 482 forms a chamfered edge sloping radially outward until it intersects with the threaded outer surface of the threaded nipple 462. Similarly, an inner end wall 486 forms the end of the lumen 448 within the sidewall section 469 of the female connector 440 as it transitions to the positive stop flange 490 at the coupling end 454. The inner end wall 486 may be formed as a flange with a chamfered edge extending radially inward to decrease the diameter of the lumen 448. Contrastingly, opposite the inner end wall 486, an outer end wall 484 forms a reverse chamfered edge sloping radially outward, but backward, until it intersects with the threaded inner surface 456 of the receiving orifice 456. The reverse chamfer of the outer end wall 484 of the female connector 440 may be formed at the same angle as the chamfer of the outer end wall 482 of the male connector 442.

An integrally formed valve, for example, one of the integrally formed valves 400, 400′ of FIGS. 29 and 30, may be placed within the lumen 448, 449 of each of the female connector 440 and the male connector 442. In one implementation, the valve 400′ of FIG. 30 with the longer interface tip 433′ may be placed within the female connector 440 such that the interface tip 433′ extends further into the receiver orifice 456. In this implementation, the valve 400 of FIG. 29 with the shorter interface tip 433 may be placed within the male connector 442 so that it does not extend beyond the position of the interface between the outer end wall 482 and the side wall of the threaded nipple 462. In other implementations, the same integrally formed valve, e.g., either valve 400, valve 400′, or any other valve embodiment, may be positioned within both of the male connector 442 and the female connector 440.

A separate barb fitting 432 may be connected with the hose-connector ends 450, 452 of each of the female connector 440 and male connector 442. The barb fitting 432 may define a central longitudinal lumen 438 that is generally cylindrical in form. The barb lumen 438 may be of constant diameter throughout the barb fitting 432 or it may vary in diameter along the length of the barb fitting 432. The outer surface of a first end of the barb fitting 432 may be formed with a barb 430 for creating a fluid-tight seal with an elastomeric hose (not shown) placed on the barb fitting 432 over the barb 430. A second end of the barb fitting 432 may be formed as a threaded nipple 444 to interface with and engage in a fluid-tight connection with each of the female connector 440 and the male connector 442. A keyed flange 410 may be provided between the barb 430 and the threaded nipple 444. The keyed flange 410 may be formed, for example, as having hexagonal flanges with six facets forming exterior sidewalls.

Continuing with the example of FIG. 31, the valve 400′ within the lumen 448 of the female connector 440 may be placed such that the interface tip 433′ interfaces with the inner end wall 486. The opening in the inner end wall 486 may be large enough for interface tip 433′ to protrude therefrom, but narrow enough to engage with the front sealing surface 434′ of the valve 400′. The valve 400′ is held within the lumen 448 by the barb fitting 432, which is screwed into the threading 446 of the hose-connector end 450 of the female connector 440. The threading 444 of the barb fitting 432 interfaces with the threading 446 of the hose-connector end 450. The keyed flange 410 of the barb fitting 432 and the keyed flange 488 of the female connector 440 may be rotated with respect to each other before or until the two flanges 410, 488 interface, to the point that the interior face 412 of the barb fitting 432 interfaces with the rear sealing feature 426′ of the valve 400′. In this position, the valve 400′ seals against the inner end wall 486 on one end of the female connector 440 and against the interior face 412 of the hose barb 432 on the other end of the female connector 440.

Similarly, as shown in FIG. 31, the valve 400 within the lumen 449 of the male connector 442 may be placed such that the interface tip 433 interfaces with the inner end wall 480. The opening in the inner end wall 480 may be large enough for interface tip 433 to protrude therefrom, but narrow enough to engage with the front sealing surface 434 of the valve 400. The valve 400 is held within the lumen 449 by the barb fitting 432, which is screwed into the threading 447 of the hose-connector end 452 of the male connector 442. The threading 444 of the barb fitting 432 interfaces with the threading 447 of the hose-connector end 452. The keyed flange 410 of the barb fitting 432 and the keyed flange 470 of the male connector 442 may be rotated with respect to each other before or until the two flanges 410, 470 interface, to the point that the interior face 412 of the barb fitting 432 interfaces with the rear sealing feature 426 of the valve 400. In this position, the valve 400 seals against the inner end wall 480 on one end of the male connector 442 and against the interior face 412 of the hose barb 432 on the other end of the male connector 442.

The female connector 440 and the male connector 442 are configured to couple with each other at an interface 439 at which the threaded nipple 462 of the male connector 442 is engaged with the threading 458 in the inner sidewall surface of the receiver orifice 456 in the female connector 440. In order to assist the coupling between the female and male connectors 440, 442, the keyed flange 488 of the female connector 440 and the keyed flange 470 of the male connector 442 may be rotated with respect to each other in order to engage the female connector 440 with the male connector 442 using one or more tools, for example, a crescent wrench. The female connector 440 and the male connector 442 may be considered fully engaged when the positive stop flange 490 of the female connector 440 fully interfaces with the positive stop flange 472 of the male connector. Additionally, or alternatively, full engagement between the female connector 440 and the male connector 442 may be considered complete when the outer end wall 482 of the male connector 442 fully interfaces with the outer end wall 484 of the female connector 440.

In operation, when the coupling end 454 of the female connector 440 is engaged with the coupling end 460 of the male connector 442 by screwing the two together, the interface tips 433, 433′ of each of the valves 400, 400′ interface with each other. As the female connector 440 and the male connector 442 are tightened together at the connection interface 439, the tips 433, 433′ of the valves 440, 442 interact and the valves 440, 442 begin to longitudinally compress. In this way, the seal between the front sealing surface 434, 434′ of the valves 400, 400′ is removed by pushing the front sealing surfaces 434, 434′ away from their rest position against the inner end walls 480, 486, this allows fluid to flow between the female and male connectors 440, 442 within the respective lumen 448, 449, including within and about the fluid passages 422, 422′ defined by the apertures 424, 424′ within each of the bodies of the valves 440, 442.

In one implementation, the female and male connectors 440, 442 may be formed with a plurality of longitudinal ribs 464 along the interior sidewall 466 forming the lumen 448, 449, as shown with respect to the male connector 442 in FIGS. 32-34. The ribs 464 may be provided to keep the valves 400, 400′ straight when under compression so that the valves 400, 400′ compress only in a longitudinal direction. The ribs 464 thus counter possible twisting and related shear forces on the valves 400, 400′ as the female and male connectors 440, 442 are screwed together. In some embodiments the ribs 464 may be of a consistent cross-sectional form and area while in other embodiments, the ribs 464 may taper as they extend from the inner end walls 480, 486 toward the hose connector ends 452, 450, respectively.

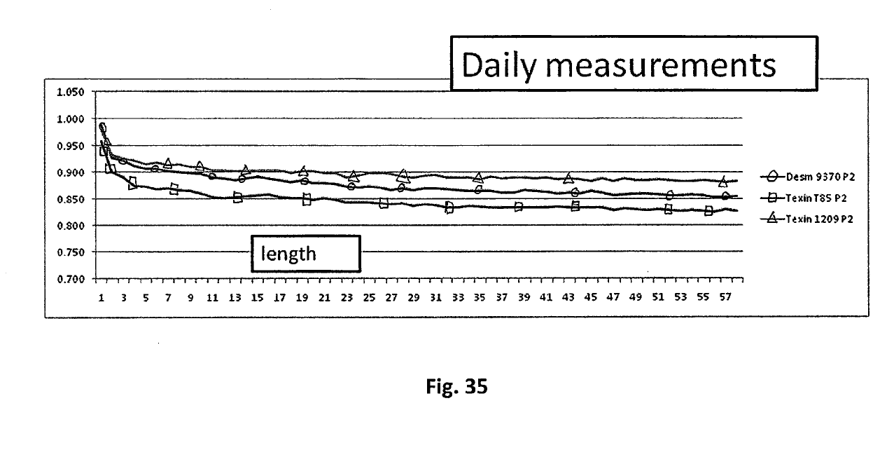

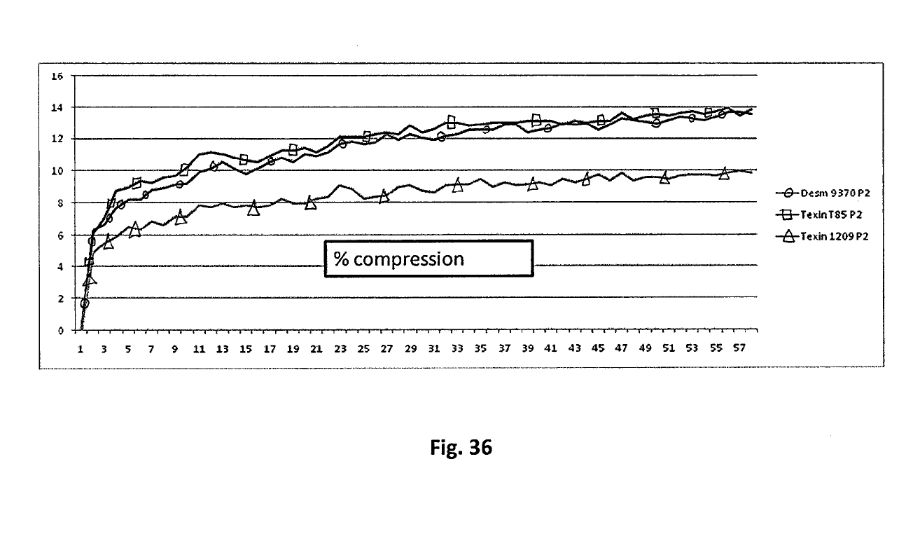

As described above, the elastomeric frenestrated tubular member (also referred to as a “dart”) may be a one-piece injection molded body that is used as the valve, or part of the valve, within the valve connectors. The material utilized for the dart has compression set characteristics that aid in insuring that the dart makes a seal as intended in the channel formed within the valve housings or bodies, as explained above, when the valve housings are disconnected from one another. Materials utilized may have particular or unique compression set variables. When the dart is placed in a compressed state, the compression set specific to that material will cause the dart to not return to its original length. Compression set of a given material can also be understood as related to yield stress in the area of strength of materials world. As an example, if a materials listed compression set is 10%, a simple calculation can be done to understand that if the dart is compressed more than 10% of its original length and held for a undetermined amount of time, it should always return to some length located between the original length and the new compression set length. FIGS. 35 and 36 below show an example of 3 darts that have been placed in a compressed state beyond the calculated length and measured on a daily basis for a certain amount of time. In FIG. 35, the x-axis is the number of days and the y-axis is the length (for instance, in inches or centimeters). In FIG. 36, the x-axis is the number of days, and the y-axis is the percent (%) compression of the length. The materials used for these darts are made by Bayer, and are Desm 9370 P2, Texin T85 P2, and Texin 1209 P2. Once the new compressed length of the dart is established, the valve connector can be designed such that the dart will likely not get shorter in length than the new compressed length and will likely extend within the connector to create a seal within the orifice when the portions of the valve connector are separated.

While exemplary embodiments of shutoff valves and integrated components have been discussed herein, other implementations are possible and fall within the scope of the present disclosure. For example, rather than a tapered, fenestrated tube, the fenestrated tube may be substantially cylindrical or have an inverted taper (i.e., tapering larger toward a front sealing member. Additionally, locking mechanisms other than pushbutton mechanisms may be implemented to secure a connection between two sides of a connector. Thus, while the present disclosure has been described in the context of specific embodiments, such descriptions are provided for illustration and are not intended to limit the scope of the present disclosure.

Indeed, it should be understood that the described shutoff valves within fluid connectors may include integrated valve components having spring and sealing characteristics as well as providing fluid pathways. Additionally, individual features of the specific embodiments may be combined and implemented with features of other embodiments to achieve a desired functionality. Further, the spring members may be used in a variety of other spring related applications not limited to shutoff valves. Thus, it is intended that all matter contained in the above description and shown in the accompanying drawings shall be interpreted as illustrative and not limiting. Changes in detail or structure may be made without departing from the basic elements of the invention as defined in the following claims.

1. A fluid conduit connector including a shutoff valve comprising
a housing defining a fluid flow cavity;
an integrally formed shutoff valve configured to be positioned within the cavity and further comprising
a sealing structure for providing a seal between the integrally formed shutoff valve component and a wall of the housing defining the cavity; and
a spring region tapering from a first end towards the sealing structure, and defining one or more fluid pathways between an outer surface and an inner surface of the integrated valve component.

2. The fluid conduit connector of claim 1, wherein at least one portion of the spring region contacts an inner sidewall of the housing and at least one portion of the spring region is spatially separated from the inner sidewall of the housing.

3. The fluid conduit connector of claim 1, wherein the spring region comprises a plurality of helical structures.

4. The fluid conduit connector of claim 1, wherein the spring region comprises a fenestrated tube.

5. The fluid conduit connector of claim 4, wherein the fenestrated tube comprises a plurality of geometric apertures radially oriented about the spring region.

6. The fluid conduit connector of claim 1, wherein the integrally formed valve component further comprises an alignment tip.

7. The fluid conduit connector of claim 6, wherein the integrally formed valve component further comprises a barbed fitting on an end opposite the alignment tip.

8. The fluid conduit connector of claim 6, wherein the alignment tip further comprises a pocket.

9. The fluid conduit connector of claim 7, wherein the pocket comprises an inwardly tapered lip.

10. The fluid conduit connector of claim 9 further comprising a plunger configured to be positioned within the pocket.

11. The fluid conduit connector of claim 10, wherein the plunger and pocket are configured to fit together in a dovetailed manner.

12. The fluid conduit connector of claim 1 further comprising a barbed fitting extending from an end of the housing.

13. The fluid conduit connector of claim 12, wherein the barbed fitting is integrally formed as part of the housing.

14. The fluid conduit connector of claim 12, wherein the barbed fitting comprises a separate component with a threaded nipple on one end for coupling the barbed fitting with a corresponding threaded receiving cavity in the end of the housing.

15. The fluid conduit connector of claim 1 wherein the at least one sealing member comprises at least one of a rear sealing member and a front sealing member for creating a seal between the integrally formed shutoff valve component and the housing.

16. The fluid conduit connector of claim 1, further comprising a sealing member circumferentially located on the integrally formed shutoff valve component and configured to provide a seal between the cover and the integrally formed shutoff valve component when the spring region is extended.

17. The fluid conduit connector of claim 1, wherein the housing further defines multiple fluid pathways, and each of the multiple fluid pathways houses a respective integrally formed shutoff valve.

18. The fluid conduit connector of claim 1, wherein an inner wall of the housing defining the fluid flow cavity further defines a plurality of longitudinally extending ribs.

19. A spring member for use as a poppet in a shutoff valve made at least in part of an elastomeric material, wherein
the spring member defines a longitudinal interior lumen configured to form a portion of a flow pathway;
the spring member tapers from a first end to a second end; and
the spring member is integrally formed with at least one of an interface member, a sealing member, or a barbed end.

20. The spring member of claim 19 further comprising one or more helical structures.

21. The tapered spring member of claim 19 further comprising a fenestrated tubular member.

22. The spring member of claim 19, wherein
the spring member has a first diameter and a second diameter and is integrally formed with the interface member and the barbed end; wherein
the first diameter is approximately the same as a diameter of the barbed end; and
the second diameter is approximately the same as a diameter of the interface member.

23. The spring member of claim 19, wherein the sealing member comprises a front sealing member and a rear sealing member.

24. The spring member of claim 19 further comprising an alignment tip defining a pocket with an inwardly tapered perimeter lip for receiving a plunger.

25. A fluid conduit connector comprising
a housing defining a fluid flow cavity;
an integrally formed shutoff valve positioned within the cavity and further comprising
a fenestrated tubular spring;
a first sealing feature located at a front of the integrally formed shutoff valve;
a second sealing feature located at a rear of the integrally formed shutoff valve, wherein
each of the first and second sealing features provides a seal between the integrally formed shutoff valve and the housing; and
an alignment tip.

26. The fluid conduit connector of claim 25, wherein the alignment tip further comprises a pocket having an inwardly tapered lip; and
the fluid conduit connector further comprises a plunger configured to engage the pocket.

27. A fluid conduit connector system comprising
a first connector comprising
a first housing defining a fluid flow cavity;
an first integrally formed shutoff valve positioned within the fluid flow cavity and further comprising a tubular spring body;
a front sealing feature located at a first end of the first integrally formed shutoff valve;
a rear sealing feature located at a second end of the first integrally formed shutoff valve, wherein
each of the front and rear sealing features provides a seal between the integrally formed shutoff valve and the housing; and
an alignment tip;
a receiving structure formed within an end of the first housing;
second connector comprising
a second housing defining a fluid flow cavity;
a second integrally formed shutoff valve positioned within the fluid flow cavity and further comprising
a tubular spring body;
a front sealing feature located at a first end of the second integrally formed shutoff valve;
a rear sealing feature located at a second end of the integrally formed shutoff valve, wherein
each of the front and rear sealing features provides a seal between the integrally formed shutoff valve and the housing; and
an alignment tip;
an insertion structure formed within an end of the second housing; wherein
the second connector couples with the first connector by engaging the insertion structure within the receiving structure;
the alignment tip of the first integrally formed shutoff valve interfaces with the alignment tip of the second integrally formed shutoff valve; and
the first and second integrally formed shutoff valves longitudinally compress as the first and second connectors are coupled together.

28. The fluid conduit connector system of claim 27, wherein the insertion structure is a threaded nipple and the receiving structure is a threaded orifice.

29. The fluid conduit connector system of claim 27 further comprising
a first barbed fitting extending from an end of the first housing opposite the receiving structure; and
a second barbed fitting extending from an end of the second housing opposite the insertion structure.

30. The fluid conduit connector system of claim 29, wherein the first barbed fitting is integrally formed as part of the first housing, the second barbed fitting is integrally formed as part of the second fitting, or both.

31. The fluid conduit connector system of claim 29, wherein either or both of the first barbed fitting and the second barbed fitting comprises a separate component with a threaded nipple on one end for coupling the first or second barbed fitting, respectively, with a corresponding threaded receiving cavity in the end of the first or second housing, respectively.

32. The fluid conduit connector system of claim 27, wherein the tubular spring body is fenestrated.

33. The fluid connector system of claim 27, wherein the each of the first and second tubular spring bodies is integrally formed, at least in part, as a molded elastomer, a thermoplastic, a thermoset, or a combination of any of the preceding materials.

34. The fluid conduit connector of claim 1, wherein a volume defined by one or more interior surfaces of the tapered spring region remains substantially constant along a length of the tapered spring region.

35. The fluid conduit connector of claim 34, wherein the spring region comprises
a first helical structure having a first cross-sectional area that is smaller at the sealing structure than at the first end; and
a second helical structure having a second cross-sectional area that is smaller at the sealing structure than at the first end.

36. The fluid conduit connector of claim 1, wherein a volume defined by one or more interior surfaces of the tapered spring region reduces along a length of the tapered spring region between the first end and the sealing structure.
